(19) United States
(12) Patent Application Publication
(10) Pub. No.: US 2015/0174584 A1
(43) Pub. Date: Jun. 25, 2015

(54) Mill Apparatus With Underslung Mill Units

(71) Applicant: International Innovative Technologies, Limited, Gateshead Tyne and Ware (GB)

(72) Inventor: George Ord, Gateshead Tyne and Ware (GB)

(21) Appl. No.: 14/418,495

(22) PCT Filed: Jul. 31, 2013
(86) PCT No.: PCT/GB2013/052052

§ 371 Date: Jan. 30, 2015

(30) Foreign Application Priority Data
Jul. 31, 2012 (GB) 1213777.4

(51) Int. Cl. B02C 17/18

(52) U.S. Cl. CPC B02C 17/18

(57) ABSTRACT

A mill apparatus (1) comprises a frame (2), a mill unit (5), a mill drive (3) mounted on the frame (2) with the mill unit (5) attached to and suspended from the mill drive (3). The frame (2) supports a part of the mill unit (5) when in a state of disassembly and allows for removal and replacement of a part of the mill unit (5).

### FIELD OF THE INVENTION

The present invention relates to mill apparatus, and in particular to such an apparatus facilitating easy servicing.

### BACKGROUND OF THE INVENTION

In some milling applications it is necessary to change wearing parts very often, as frequent as every few hours in some applications.

This is normally a time consuming process which results in the mill being out of operation for a significant period of time.

It would therefore be desirable to provide an apparatus which provides for easy servicing and the more efficient use of mills.

### SUMMARY OF THE INVENTION

According to the invention there is provided a mill apparatus comprising a frame, a mill unit, a mill drive mounted on the frame with the mill unit attached to and suspended from the mill drive.

Preferably, the frame is adapted to support the mill unit when detached from the mill drive, and advantageously, when lowered with respect to the mill drive.

The mill unit advantageously includes a housing. Preferably, the housing and the frame include co-operating elements adapted to constrain lateral movement of the mill unit with respect to the frame. The co-operating elements may include a pin and hole for receiving the pin.

Preferably, the frame provides space between members thereof for the removal of a detached mill unit laterally with respect to the frame.

According to another aspect of the invention there is provided a method of removing a part of a mill unit comprising the steps of:

Supporting the mill unit;

Releasing the mill unit from the mill drive;

Lowering the mill unit so that it is supported by the frame;

Releasing a part of the mill unit requiring servicing or replacement;

Lifting that part of the mill unit and removing it through an opening in the frame.

### BRIEF DESCRIPTION OF THE DRAWINGS

In the Drawings, which illustrate preferred embodiments of the invention:

FIG. 1a is a schematic cross-sectional representation of mill apparatus according to one aspect of the invention;

FIG. 1b is a schematic representation of the mill apparatus shown in FIG. 1a in a partially disassembled state;

FIG. 1c is an exploded view of a part of the mill apparatus shown in FIGS. 1a and 1b; and

FIG. 2 is a schematic representation of a lifting bracket.

### DETAILED DESCRIPTION OF THE PREFERRED EMBODIMENTS

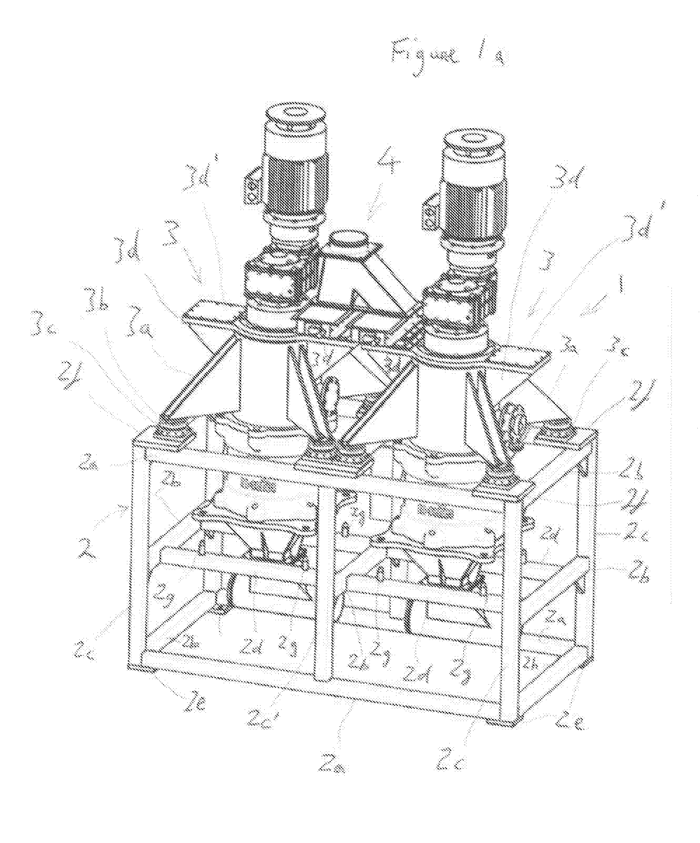

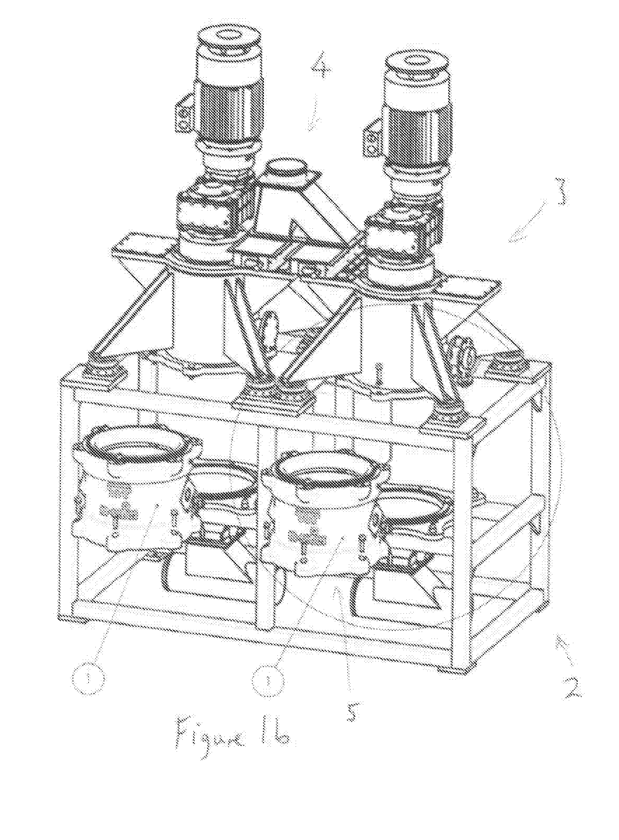

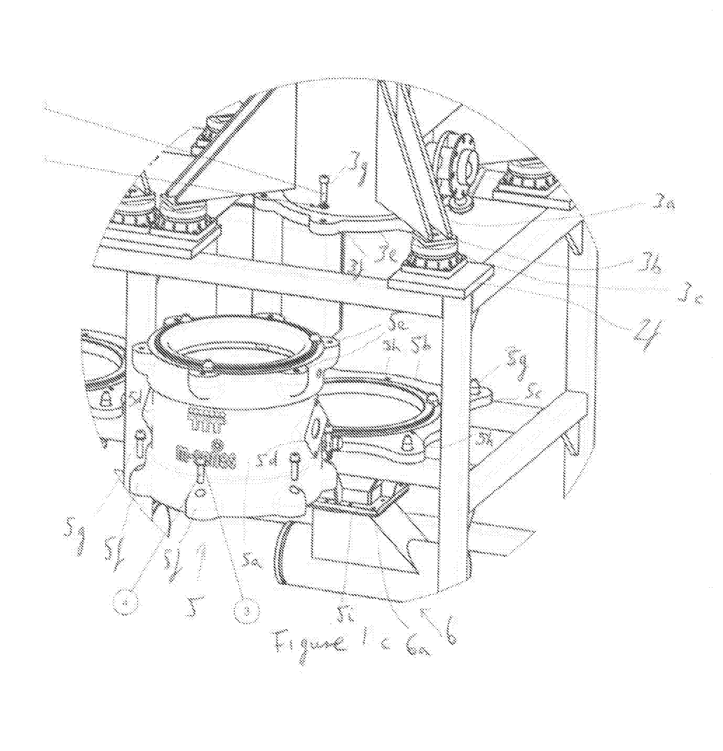

FIGS. 1a to 1c illustrate a mill apparatus 1 comprising a frame 2, a pair of mill drives 3, a feeder 4 and a pair of mill units 5.

The apparatus 1 provides for the easy removal and re-attachment of a mill unit 5 to its respective drive 3.

The frame 2 comprises longitudinal upper and lower cross-members 2a extending between corner upright members 2c, lateral cross-members 2b, longitudinal cross-members 2d extending between the lateral cross-members 2b, and central upright members 2c′ extending between upper and lower cross-members 2a.

The frame 2 further comprises feet 2e located at the corners of the frame on the underside thereof, and pads 2f located at the corners of the frame on the underside thereof.

Each mill unit 5 is attached to a drive housing 3 having brackets 3a. Each bracket 3a mounts a foot 3b which sits on the pad 2f with an isolation pad 3c situated between the foot 3b and pad 2f.

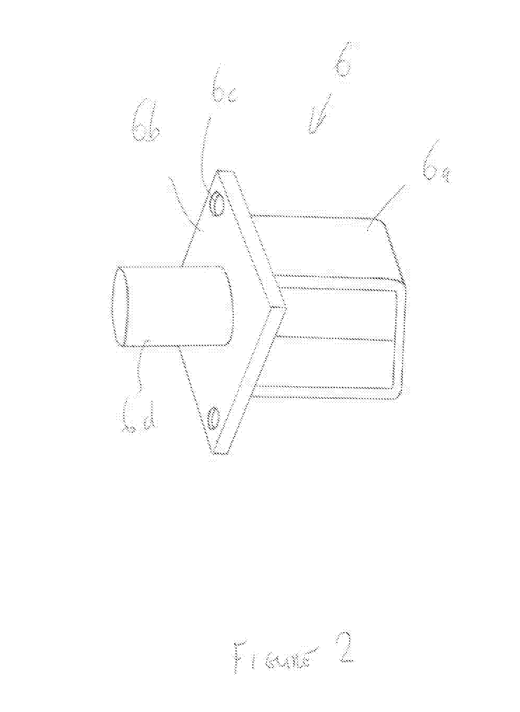

The mill unit 5 includes a mill housing 5a and an end member 5b. The end member 5b includes bores 5c which are configured to locate on pins 2g mounted on cross-members 2d. The housing 5a includes lifting bracket receiving members 5d. The lifting brackets 6, shown in FIG. 2 comprise a bracket 6a configured to receive the fork of a forklift truck for example, a flange 6b having holes 6c through which bolts may pass to attach the bracket 6 to the lifting bracket receiving member 5d, and a boss 6d for engaging the lifting bracket receiving member 5d.

The drive housing 3 includes a rim 3e from which extend bolt receiving portions 3f. As can be seen from FIG. 1c, a bolt 3g passes through an aperture in the bolt receiving portion 3f and into a threaded bore of a bolt receiving portion 5e of the mill housing 5a.

The mill housing 5a also includes bolt receiving portions 5f, through which bolts 5g pass to engage with threaded apertures 5h located in end member 5b.

Material outlet apparatus 6 includes a bracket 6a which attaches to a bracket 5i of the end member 5b.

To remove one of the mill units 5 from the apparatus 1, lifting brackets (illustrated in FIG. 2) are attached to the lifting bracket receiving members 5d. The mill unit 5 is supported through the lifting brackets, for example on the forks of a forklift truck. The bolts 3g are removed, which allows the mill unit 5 to be lowered until the end member 5b is supported on the cross-members 2d of the frame 2 with the pins 2g located in bores 5c.

With the end member 5b securely supported on the frame 2, bolts 5g are removed from threaded apretures 5h, releasing the housing 5a from the end member 5b. The mill housing 5a, supported by a lifting means such as a forklift truck may then be removed, and replaced with another mill housing 5a.

The apparatus 1 provides for the very straightforward removal and replacement of mill housings 5a for servicing and repair. When milling very hard materials, the mill housing 5a and the components supported therein may require serving and repair every few hours. Therefore it is desirable to provide for the easy removal and replacement off the mill housing 5a.

In the apparatus 1 the mill drive housing 3 is mounted above the mill unit 5. Not only does this allow for an arrangement wherein the mill housing 5a may easily be removed, but also the mill drive components located in the housing 3 are less likely to be infiltrated by dust and other material passing through the mill, because they are located gravitationally above the mill unit 5.

Further, by facilitating the support of the mill units 5 on the apparatus when detached from the drive housings 3, the drive housings 3 may also be removed for servicing and repair.

Whilst the illustrated example shows a pair of mill units 5, the apparatus may comprise only one mill unit 5, or may comprise more than two mill units 5.

An outlet 6 extends downwardly from the underside of the mill unit 5. With the apparatus dismantled, as illustrated in FIGS. 1b and 1c, the outlet 6 is nevertheless supported above the ground by the frame.

As can be seen from FIGS. 1a and 1c, the drive housing 3 includes in feed elements 3d to each side of the housing. The outer element 3d of each housing 3 is blanked off with a blanking plate 3d′. The inner in feed elements 3d are each attached to a feeder 4. The provision of each drive housing with two in feed elements allows multiple products to be introduced to the mill 5. The feeder 4 may include a plate to block the feeding of material to one of the mill units, for example if one of the mill units 5 is removed for servicing and not immediately replaced, the feeder 4 may be adjusted so that material is fed only to the remaining mill.

1. A mill apparatus comprising a frame, a mill unit, a mill drive mounted on the frame with the mill unit attached to and suspended from the mill drive; wherein the frame is adapted to support the mill unit when said mill unit is detached from the mill drive.

2. (canceled)

3. A mill apparatus according to claim 1, wherein the frame is adapted to support the mill unit when the said mill unit is lowered with respect to the mill drive.

4. A mill apparatus according to claim 2, wherein with the said mill unit in its lowered position, the lower part of the mill unit is supported in the non-ground engaging position.

5. A mill apparatus according to claim 1, wherein the mill unit and the frame include co-operating elements adapted to constrain lateral movement of the mill unit with respect to the frame.

6. A mill apparatus according to claim 1, wherein the mill unit includes a housing and an end member, the housing releasably attachable to the mill drive and the end member.

7. A mill apparatus according to claim 5, wherein the end member and the frame include the co-operating elements adapted to constrain lateral movement of the mill unit with respect to the frame.

8. A mill apparatus according to claim 6, wherein the co-operating elements include a pin and hole for receiving the pin.

9. A mill apparatus according to claim 6, comprising a plurality of co-operating elements.

10. A mill apparatus according to claim 6, wherein the end member includes a flange and wherein the or each co-operating element of the mill unit is situated in the flange.

11. A mill apparatus according to aim claim 1, wherein the mill unit comprises a downwardly extending outlet.

12. A mill apparatus according to claim 10, wherein the mill unit includes a housing and an end member, the housing releasably attachable to the mill drive and the end member, and wherein the outlet extends from the end member.

13. A mill apparatus according to claim 1, wherein the frame includes a plurality of frame members and wherein the frame provides space between members thereof for the removal of a detached housing of the mill unit laterally with respect to the frame.

14. A mill apparatus according to claim 1, further comprising a feeder configured to feed material to a mill unit.

15. A mill apparatus according to claim 1, comprising a plurality of mill units and a corresponding plurality of mill drives, all mounted on a common frame.

16. A mill apparatus according to claim 14, further comprising a feeder configured to feed material to more than one of the mill units.

17. A mill apparatus according to claim 15, wherein the feeder is configured to feed material to adjacent mill units.

18. (canceled)
